(19) United States
(12) Patent Application Publication
(10) Pub. No.: US 2005/0021460 A1
(43) Pub. Date: Jan. 27, 2005

(54) Method and system to process a transaction in a network based commerce facility

(76) Inventors: Don Teague, San Jose, CA (US); Joe Lynam, Cupertino, CA (US); Greg Calcagno, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/624,837

(22) Filed: Jul. 21, 2003

(51) Int. Cl. G06F 17/60

(52) U.S. Cl. 705/40

(57) ABSTRACT

A method and apparatus to facilitate predictive presentment of the payment options. In transactions between a purchaser and a vendor, the vendor may obtain personal information from the purchaser at an early stage of the sale. The personal information may be used to identify a list of approved payment options. The approved payment options can be predictively or dynamically presented to the purchaser based on the business rules that account for various factors including, but not limited to: purchaser payment psychology, available payment methods, credit score by payment method type, credit score across payment method types, vendor payment option preference, and type of purchase event.

### FIELD OF THE INVENTION

The present invention relates generally to the field of financial transactions and, more specifically, to method and system to process a transaction in a network-based commerce facility.

### SUMMARY OF THE INVENTION

According to one aspect of the present invention, there is provided a method to communicate payment options to a consumer. The method includes receiving consumer information, identifying at least one approved payment option utilizing the consumer information, and communicating the at least one approved payment option to the consumer.

The method may include monitoring a request by a consumer for a further payment option.

In one embodiment, identifying the at least one approved payment option includes generating a reliability score value utilizing the consumer information. Identifying at least one approved payment option may include identifying an available payment option from a plurality of available payment options as an approved payment option for the consumer, utilizing the consumer information.

The method may include storing the approved payment option for the consumer for use in future transactions.

In certain embodiments, the plurality of available payment options include at least one of a credit card option, a phone bill option, an ACH option, a payment by check option, a direct bill option, and a prepayment option.

The method may also include identifying a payment option presentation format.

Identifying the at least one approved payment option to the consumer may include identifying a payment option utilizing at least one of vendor criteria, consumer criteria, type of purchase event criteria, and purchaser payment psychology.

Further in accordance with the invention, there is provided a system to present payment options to a consumer. The system includes a communication module to receive first consumer information, an approved payment options generator module to generate a list of at least one approved payment options utilizing the consumer information, and a selection module to present the consumer with an option to select a payment option from the list of at least one approved payment options.

In one embodiment the operation includes providing additional consumer information.

In one exemplary embodiment, the payment options generator module includes a payment option validation module to identify an available payment option from a plurality of available payment options as an approved payment option utilizing the consumer information. The payment options generator module may include a payment options rules engine to determine reliability score value for the consumer. The plurality of available payment options include at least one of a credit card option, a phone bill option, an ACH option, a payment by check option, a direct bill option, and a prepayment option. In one embodiment, the payment options rules engine may identify a payment options presentation format, utilizing at least one of a vendor criteria, a consumer criteria, a type of purchase event criteria, and a purchaser payment psychology.

In one embodiment, the payment options rules engine may be utilized to determine the order of payment options presentation.

Still further in accordance with the invention, there is provided a method to present payment options to a consumer, the method including:
providing consumer information associated with the consumer to a transaction processing facility;
receiving at least one approved payment option from a plurality of payment options from the transaction processing facility based on the consumer information, the at least one payment option being valid for the consumer; and
presenting the at least one approved payment option to the consumer for selection by the consumer.

The method may include:
monitoring a request by the consumer for a further payment option, the further payment option being distinct from the at least one approved payment option;
obtaining additional consumer information from the consumer;
communicating the additional consumer information to the transaction processing facility; and
receiving one of an approval of the further payment option for the consumer, and a rejection of the further payment option for the consumer.

The invention also extends to a machine-readable medium embodying a sequence of instructions for executing any one or more of the methodologies described herein.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, and in which:

FIG. 1 is a schematic block diagram of a prior art system for processing a transaction concluded via the Internet.

FIG. 2 is a schematic representation of a system, according to one embodiment of the present invention, for processing a transaction via a network-based commerce facility.

FIG. 3 is a schematic block diagram of transaction processing equipment according to one embodiment of the present invention.

FIG. 4 is a schematic representation of a payment option rules engine, according to one embodiment of the present invention.

FIG. 5 is a schematic diagram of the interaction between various participants in the transaction processing system according to one embodiment of the present invention.

FIGS. 6 and 7 are schematic operational flow diagrams of two exemplary methods, according to one embodiment of the present invention, to process a transaction in a network-based commerce facility to facilitate presentment of the approved payment options.

FIG. 8 shows an exemplary entry interface for obtaining user information.

FIG. 9 shows an exemplary selection interface whereby a user may select a payment method.

FIG. 10 is a diagrammatic representation of a machine in the exemplary form of a computer system within which a set of instructions, for causing the machine to perform any one of the methodologies discussed herein, may be executed.

### DETAILED DESCRIPTION

In a transaction between a purchaser (e.g., a consumer) and a vendor (e.g., a merchant), if the purchaser wishes to pay using a credit card, the merchant typically obtains details of the credit card from the purchaser and verifies the transaction via a credit card gateway prior to finalizing the transaction. Certain vendors, in order to facilitate transactions with purchasers who do not have credit cards, may offer the option of having the charges related to a particular transaction applied to another account (e.g., a utility account) of the purchaser. It will however be appreciated that some purchaser verification may be associated with any payment option. For example, if the purchaser wishes to pay by applying a charge to a telephone bill, it is desirable to provide a method whereby the merchant can verify the transaction and the identity of the purchaser in control of the payment instrument.

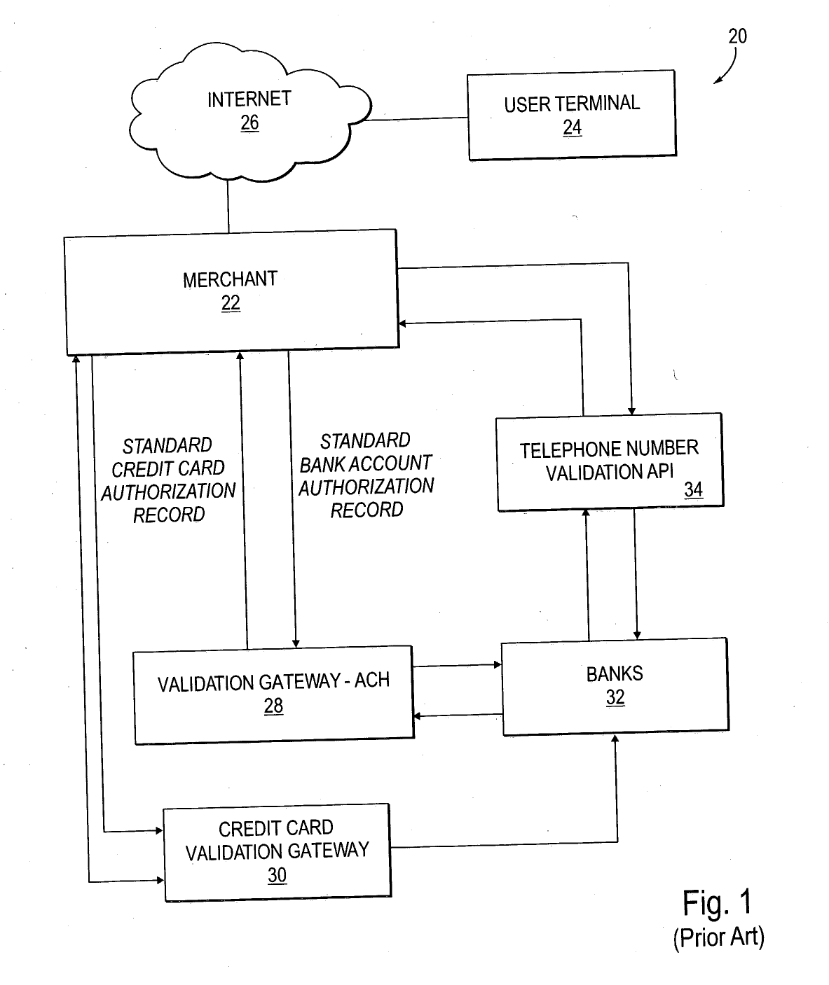

Referring to FIG. 1, reference numeral 20 generally indicates a prior art system for processing a transaction between a merchant 22 and a user or purchaser using a user terminal 24 (typically a personal computer or the like) via the Internet 26. When the user purchases goods and/or services (cumulatively referred to as products) via the Internet 26, the user is usually prompted to enter credit card or bank account details into the user terminal 24, which are then communicated via the Internet 26 to the merchant 22.

Dependent upon the mode of payment selected, the merchant 22 then communicates an authorization record, as commonly used in the industry, to an appropriate validation gateway 28, 30 or a telephone number validation application program interface (API) 34. Usually, the merchant 22 first validates or checks whether or not the transaction can be processed by communicating with the validation gateways 28,30 or the telephone number validation API 34 and, if validated, the merchant 22 may then obtain payment for the transaction via an appropriate financial institution 32. Thus, the merchant 22 may be required to communicate a standard authorization record in the form of either a standard credit card authorization record or a standard bank account authorization record to the validation facilities 30, 28 respectively. Different records are thus communicated to different facilities dependent upon the particular payment method selected by the user. In these systems the payment option or options presented to the consumer are independent of the particular consumer.

In accordance with one aspect of the invention, if a purchase verification associated with a payment method fails, the merchant may offer another payment method option to the purchaser. This payment option may also be subjected to a verification process. In certain embodiments, each time the purchaser selects a new payment option, the merchant may need to go through a predetermined verification process to identify the particular payment option selected by the purchaser as approved or invalid. Thus, in one embodiment of the invention, all of the approved payment options for the purchaser are identified based on the purchaser's personal information obtained from the purchaser. The approved payment options for a particular purchaser thus identified may be stored for that purchaser for use in future transactions. Thus, the payment options presented to the user or customer may be based on the particular individual.

In transactions between a purchaser and a vendor (e.g., a merchant) conducted via a network-based commerce facility such as the Internet, a payment method decision for the transaction in one embodiment may be, inter alia, a combination of a purchaser payment option preference and, a vendor payment option preference. Merchants concluding transactions with purchasers via the Internet may desire to offer payment methods to purchasers that are most advantageous to the merchant. For example, the merchant may first offer to the purchaser payment options that have a higher rate of collection success followed by those payment options that have a lower rate of collection success. Likewise, a purchaser may prefer certain payment options over other payment options. In order to accommodate the purchaser, the merchant may require verification of financial instrument information in order of the purchaser's preference prior to finalizing the transaction.

In accordance with one aspect of the invention, payment method options can be predictively or dynamically presented to the purchaser based on predetermined business rules that account for various factors including, but not limited to: purchaser payment psychology, available payment methods, a credit score associated with a particular payment method type, a reliability score across payment method types, a vendor payment option presentation and a type of purchase event. The reliability score may be utilized to evaluate the purchaser's “propensity to pay” for like purchases by a particular payment method.

In the following description, for purposes of explanation, numerous specific details are set forth in order to provide a thorough understanding of the present invention. It will be evident, however, to one skilled in the art that the present invention may be practiced without these specific details.

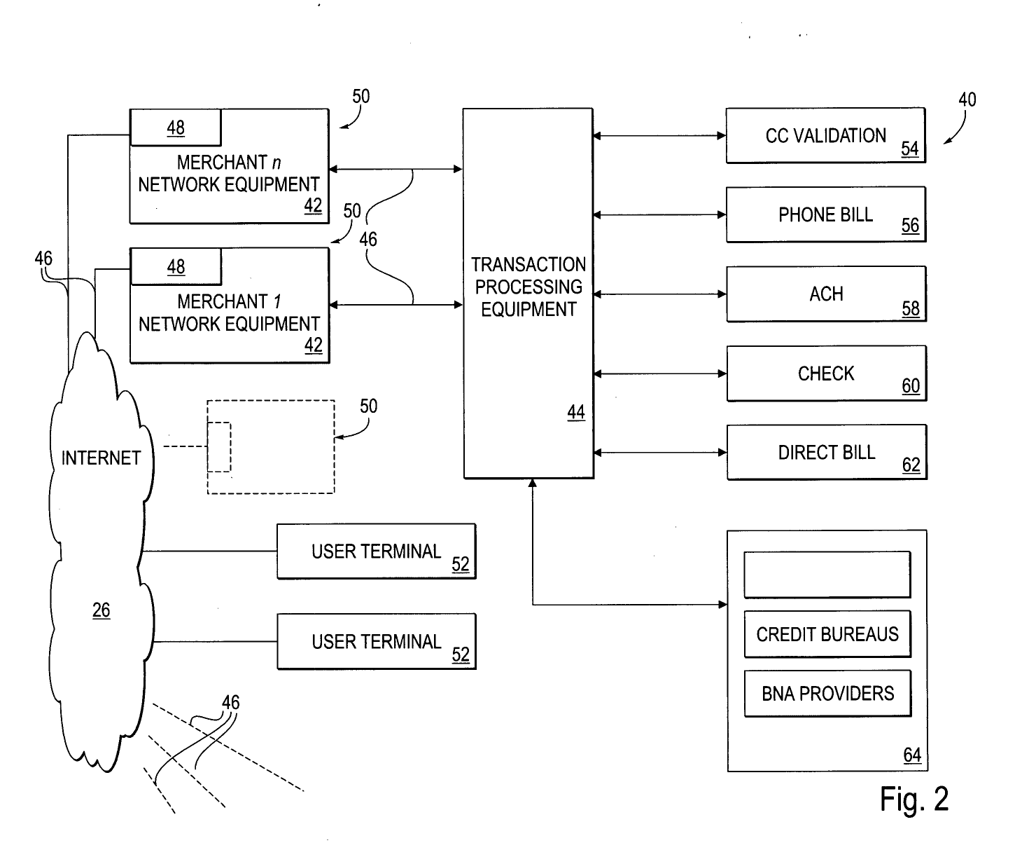

Referring in particular to FIG. 2 of the drawings, reference numeral 40 generally indicates a transaction processing system in accordance with one embodiment of the present invention. The system 40 includes merchant network equipment 42, provided at different remote merchants 50, and transaction processing equipment 44, which is configured to communicate with the merchant network equipment 42 via communication lines 46. In the embodiment depicted in the drawings, the communication lines 46 are shown as dedicated communication lines. However, it is to be appreciated that the communication lines 46 may also form part of any network-based commerce facility such as the Internet 26. The merchant network equipment 42 is connected via an Internet interface 48, which defines a user communication module, to the Internet 26 so that the merchants 50 can, via the merchant network equipment 42, offer goods and/or services (cumulatively referred to as products) for sale to a variety of users via user terminals 52 connected to the Internet 26. The user terminals 52 may be conventional personal computers (PCs) or the like.

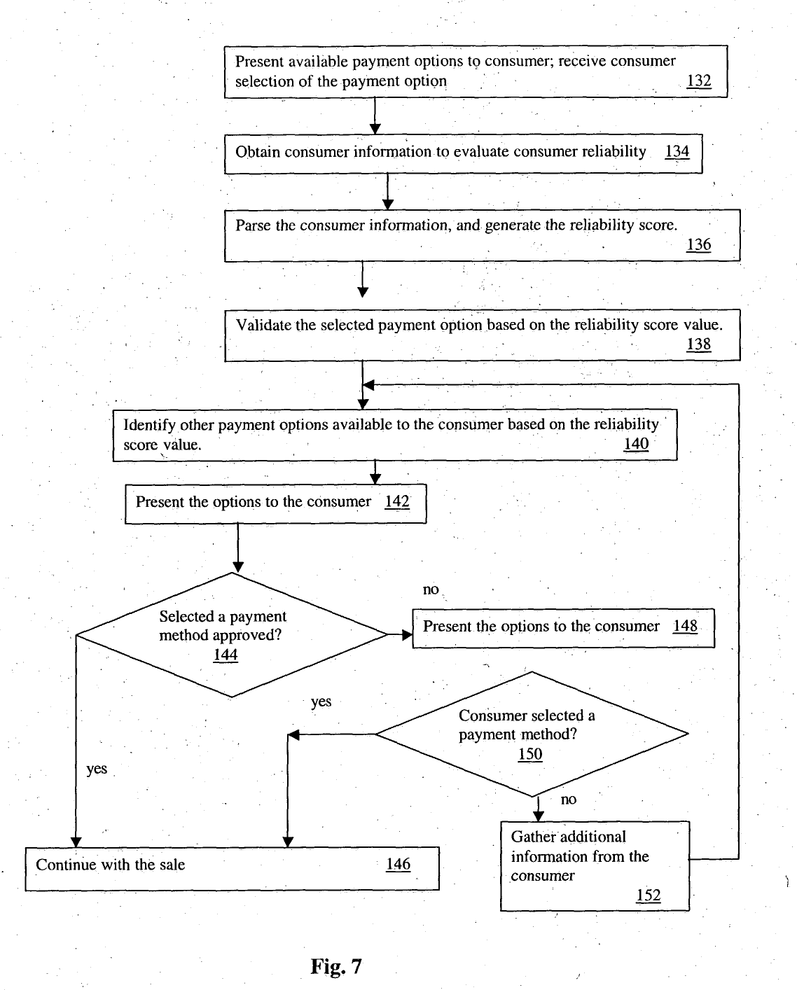

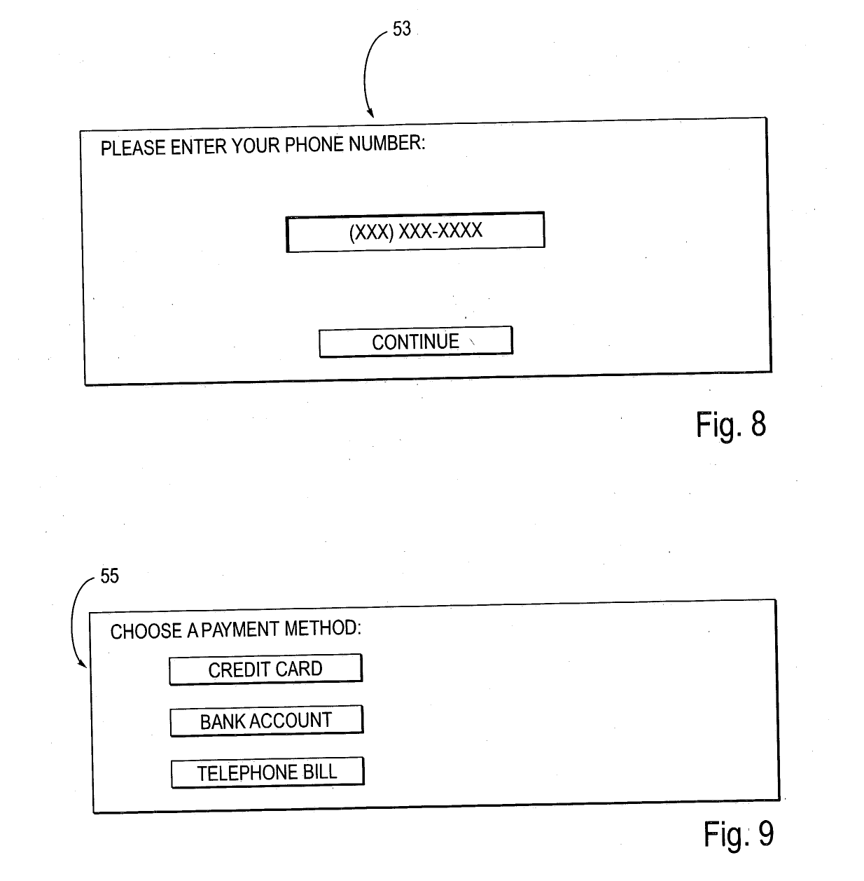

As described in more detail below, a user or purchaser may provide personal information (e.g. a telephone number via a user interface 53 as shown in FIG. 8) and, in response thereto, a plurality of payment method options may be predictively presented (e.g. via a payment option selection interface 55 as shown in FIG. 9). The user may then select a variety of different payment methods to purchase products via the Internet 26. In order to identify the payment method options presented, the merchant network equipment 42 may communicate the user's personal information (or any other identification data) to the transaction processing equipment 44. The information may include, but not be limited to, the user's personal information, such as name, address, and phone number; the information regarding the type of purchase; a merchant's rule set; and an identifier to identify a particular type of payment method selected by the user.

The transaction processing equipment 44 processes the information received from the user to identify one or more approved payment method options among available payment method options to be presented to the user (see the exemplary credit card, bank account and telephone bill options shown in FIG. 9). The available payment method options may be determined utilizing information regarding the payment methods available to the merchant, information regarding the merchant preference, and a purchase type.

If the user information received from the merchant network equipment 42 is sufficient to effectuate validation of a particular payment method, the transaction processing equipment 44 may create a transaction record to be communicated to an appropriate validation and/or billing facility such as credit card validation facility 54, a phone bill validation facility 56, an ACH validation facility 58, a check validation facility 60, or a direct bill validation facility 62. The transaction processing equipment 44 may access other information sources 64 including, for example, credit bureaus, BNA providers, etc. to perform additional validations.

When the transaction processing equipment 44 receives a response from the relevant facility 54, 56, 58, 60, 62, and 64, one or more payment method options may then be identified as an approved payment method option or as an invalid (unapproved) payment method option. Once all available payment method options have been identified as approved or invalid, a list of one or more approved payment method options is then communicated from the transaction processing equipment 44 to the merchant 50. Thus, payment method options may be predictively presented to the customer. However, in other embodiments, payment method options may be dynamically presented to the customer. In these circumstances a user may select a particular payment method, and should the particular payment method fail validation an alternative valid payment method option may be provided to the user.

In the exemplary embodiment depicted in the drawings, the user terminal 52 is shown to communicate indirectly with the transaction processing equipment 44 via the merchant network equipment 42. However, it is to be appreciated that in other embodiments of the invention, the user terminal 52 may communicate directly with the transaction processing equipment 44. Thus, the invention is equally applicable in any network-based commerce facility wherein various components of the facility communicate directly or indirectly with each other.

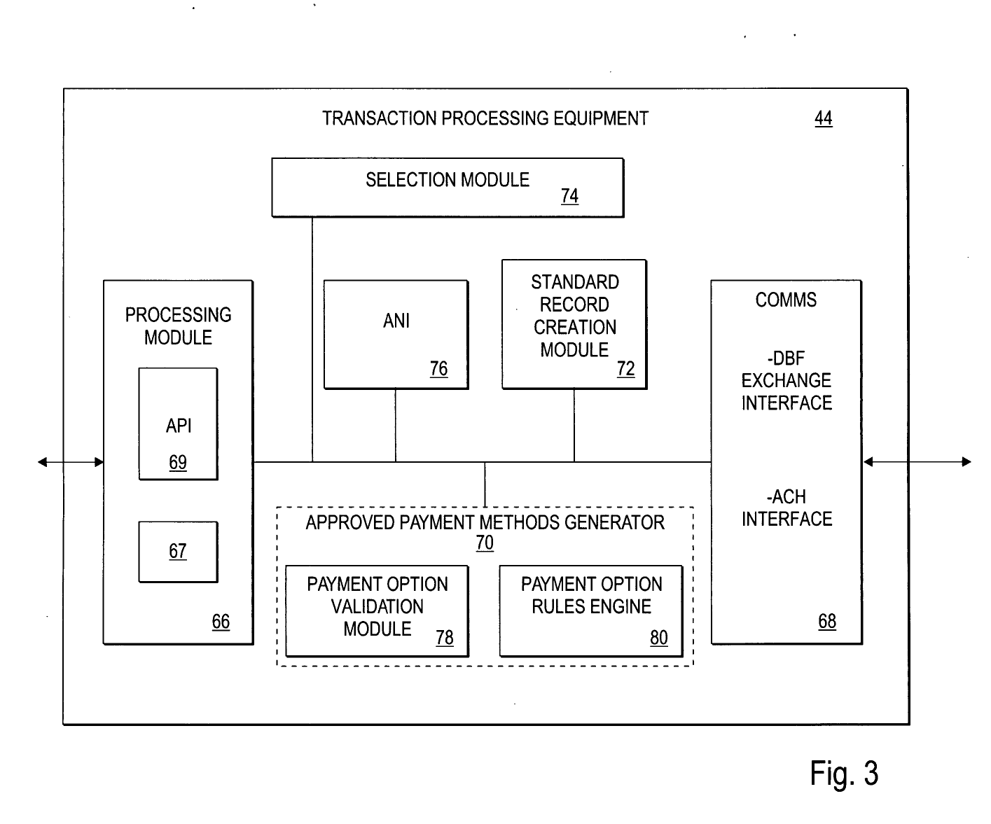

The transaction processing equipment 44 may include components illustrated in FIG. 3. For example, the transaction processing equipment 44 may include a processor module 66, a financial service communication module 68, an approved payment options generator module 70, a standard record creation module 72, a selection module 74 to present the user with the list of approved payment options, and an automatic line number identification (ANI) module 76.

The approved payment options generator module 70 may include a payment option validation module 78 to identify an available payment option from a plurality of available payment options as an approved payment option utilizing, for example, the information received from the merchant network equipment 42 (see FIG. 2). The approved payment options generator module 70 may also include a payment options rules engine 80 to determine a reliability score value for the user (e.g., the user's ‘propensity to pay’ for like purchases, for example, by a particular payment method). The payment options rules engine 80 may be used to determine the reliability score value and the order of available and approved payment options presentation format. It will be appreciated that the reliability score may be determined in different ways and differ from embodiment to embodiment. For example, the reliability score may be influenced by geographic location (e.g., a person's residential address), credit card payment history, Equifax data, birthdate and so on.

The payment options rules may account for various factors including, but not limited to: purchaser payment psychology, available payment methods, a credit score by payment method type, a credit score across payment method types, a vendor payment option presentation and a type of purchase event. Available payment methods may include credit card, bank account, phone bill, invoice, prepayment, cash, or the like.

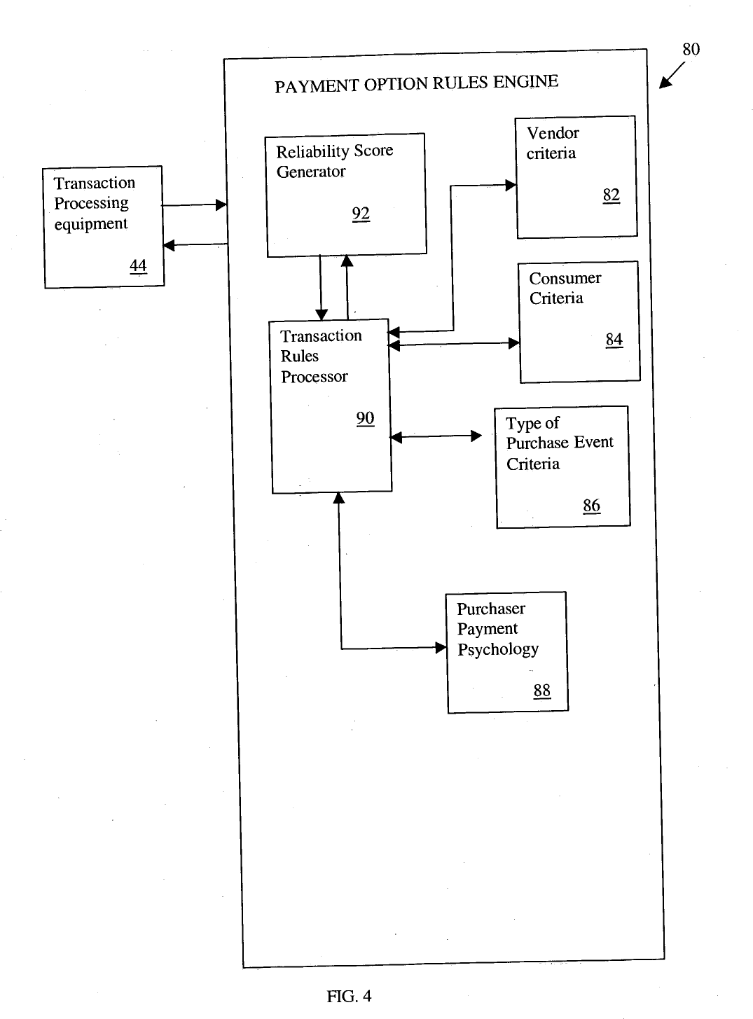

Referring to FIG. 4 of the drawings, reference numeral 80 generally indicates an exemplary embodiment of a payment option rules engine. The payment option rules engine 80 may be utilized to facilitate generation of approved payment options, including but not limited to identifying a payment option presentation format, and determining a reliability score value for a purchaser in accordance with the invention. The payment options rules engine 80 may include a vendor criteria module 82, a consumer criteria module 84, a type of purchase event criteria module 86, a purchase payment psychology module 88, and a transaction rules processor 90, and a reliability score generator 92. In one exemplary embodiment of the present invention, the payment option rules engine 80 may be separate from the transaction processing equipment 44. Accordingly, the transaction processing equipment 44 may then communicate via a communication link with the payment option rules engine 80 to facilitate generation of an approved payment options list. Thus, using one or more of the vendor criteria module 82, the consumer criteria module 84, the type of purchase event criteria module 86, and the purchaser payment psychology module 88, various different payment options may be presented to a customer.

Returning to the processor module 66 in FIG. 3, in certain embodiments, it may include a merchant communication module 67 to receive information such as the personal information of the user, the information indicating a type of purchase, the rule set of the merchant, and/or an identifier to identify a particular type of payment method selected by the user. The communication module 67 may also be used to receive and identify a transaction record associated with any one of the account types, which the user may select. The processor module 66 may also include a transaction record API 69, which extracts relevant account data and account type identifiers from the transaction record received from the merchant and, in response thereto, create an appropriate record. The appropriate record is then communicated via the financial service communication module 68 to a relevant validation facility 54, 56, 58, 60, 62 and 64.

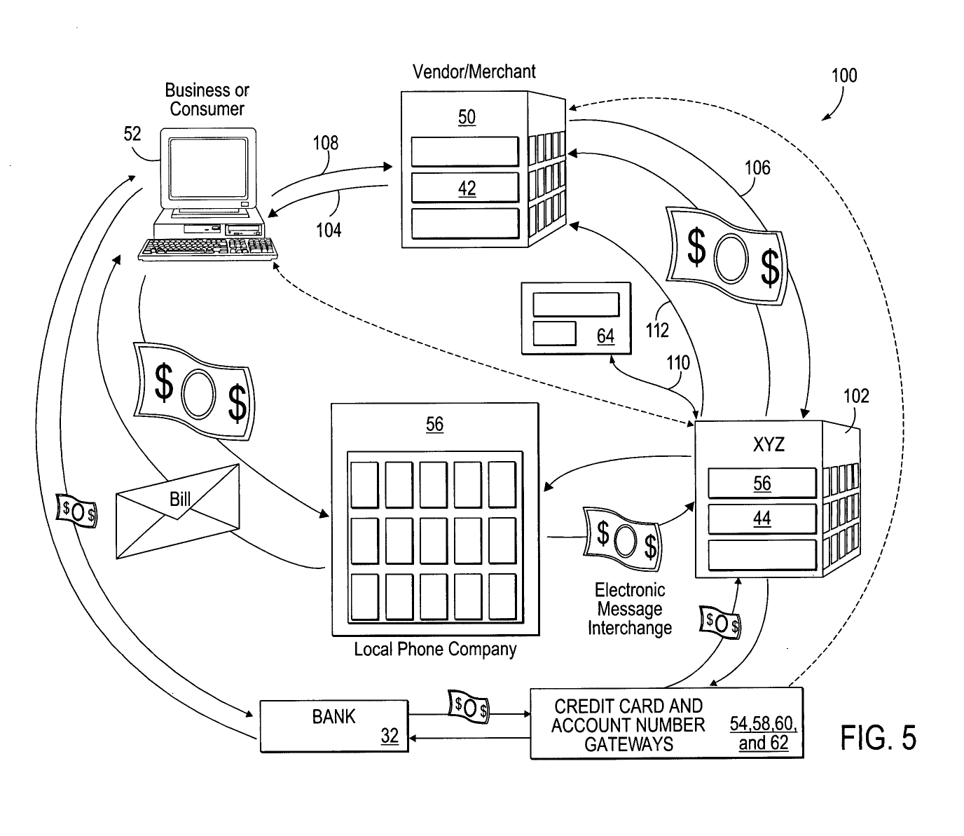

Referring in particular to FIG. 5 of the drawings, reference numeral 100 generally indicates a further embodiment of a transaction processing system in accordance with the invention. The system 100 includes components of the system 40 and, accordingly, the same reference numerals have been used to indicate the same or similar features unless otherwise indicated. In the exemplary system 100, a transaction processing facility 102 provides a one-stop transaction processing service which a vendor or merchant 50 can use to authorize transactions, effect billing for transactions, and provide collection of funds for each transaction billed.

A purchaser or a user typically purchases products from the merchant 50 using a user terminal 52. The merchant 50 using its merchant network equipment 42 communicates data, as shown by arrow 104, to the user terminal 52, which provides the user with an option to purchase products using different payment options.

In one embodiment, prior to finalizing any transaction, the merchant 50 may require validation of a particular account type or payment option, which the user has selected to effect payment. Accordingly, the merchant 50 communicates a validation request, as shown by arrow 106, to the transaction processing facility 102. In an exemplary embodiment, the request is in the form of a transaction record, which may include transaction type identification data as well as merchant identification data.

In one embodiment of the present invention, the merchant 50 may solicit information from a consumer 52 as shown by arrow 108, and, upon receiving the consumer information from the user terminal 52, communicate the information to the transaction processing facility 102, as shown by arrow 106. The consumer information may then be processed at the transaction processing facility 102 in order to generate a list of approved payment method options, which are then communicated to the merchant 50. The list of approved payment method options may then be presented to the consumer via the user terminal 52. The consumer is then requested to select a payment option among the approved payment options. If the consumer wishes to select an option that has not been approved due, for example, to insufficient consumer information, the merchant 50 may solicit additional information from the consumer 52 in order for the transaction processing facility102 to validate the selected option.

In one exemplary embodiment, the transaction processing facility 102 may utilize the payment options rules engine 80, as well as validation facilities 54, 58, 60, and 62. In one embodiment of the invention, the transaction processing facility 102 utilizes other sources of information 64; such other sources of information may include, for example, information from credit bureaus and BNA providers, to perform additional validations, as shown by arrow 110.

In one exemplary embodiment of the present invention, the transaction processing facility 102 investigates an appropriate facility (e.g., the telephone bill validation facility 56) via its transaction processing equipment 44. The transaction processing equipment 44 communicates validation data, including a list of approved payment options for the consumer, as shown by arrow 112, to the merchant network equipment 42 of the merchant 50. The merchant network equipment 42 may then communicate an appropriate response to the user terminal 52 as shown by arrow 104. The user may then be presented an option to select one of the approved payment options. The consumer or user may also be offered an option to provide additional user information.

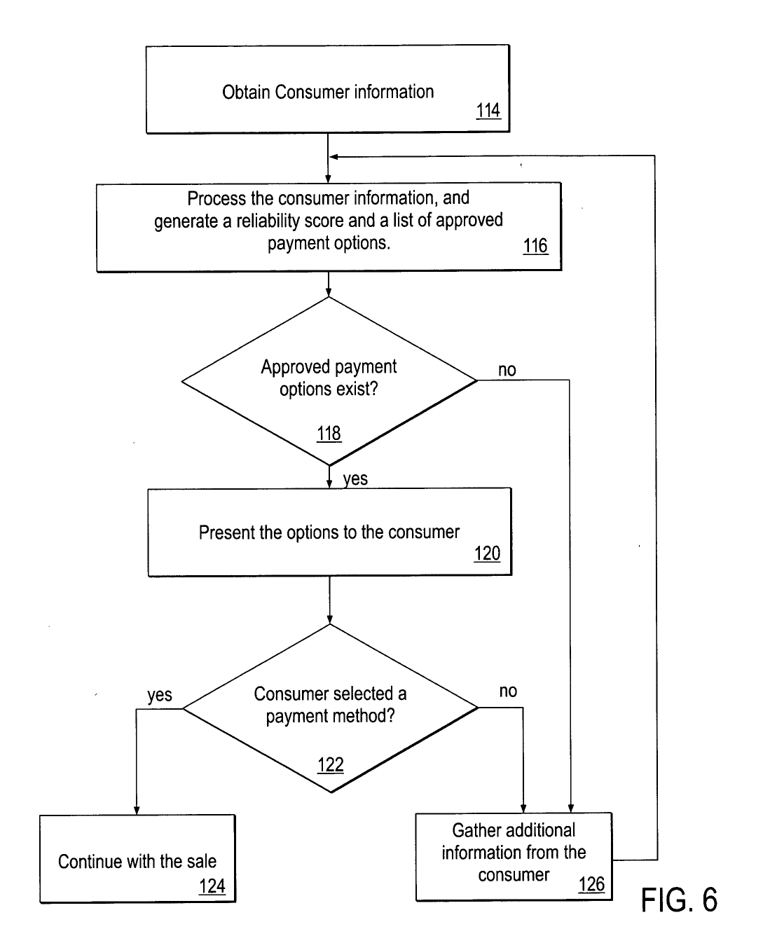

FIG. 6 is schematic operational flow diagram of a method to present approved payment options, according to one embodiment of the present invention. The consumer information is obtained at operation 114. The consumer information is then processed, and the reliability score is generated at operation 116. If it is determined at the decision operation 118 that at least one approved payment option exists, at least one approved payment option is presented to the consumer at operation 120. If one or more payment options are presented, and if the consumer makes a selection of one of the approved payment options (see operation 122), the merchant may continue with the transaction at operation 124. If the consumer wishes to select a payment method that does not appear on the approved payment methods list presented to the user, the consumer may select an appropriate indicator or button and, in response thereto, the merchant may request additional information from the consumer at block 126. This additional information may be more intrusive (e.g., a social security number, or a credit card number), and may be used to generate a new list of approved payment methods.

The invention may extend to a scenario where a transaction (e.g., a sale) is effectuated via the Internet (e.g., utilizing web services in the form of an on-line store). Furthermore, the present invention may also extend to a scenario where the approved payment method list is generated following a verbal or written communication from a purchaser. FIG. 7 illustrates exemplary operations performed where a user selects a payment option before the user is presented with the list of approved options. The latter scenario may take place at a convenience store where a user (in this case, a customer or consumer) wishes to pay for a product, for example soft drink, via his or her telephone bill. The merchant obtains the customer selection, which in turn is obtained by the transaction processing facility 102 at operation 132. The merchant (in this example, a store clerk) may obtain the user's information, including telephone number information, enter the information into a computer to communicate it to the transaction processing facility 102. The customer's information is then received by the transaction processing facility 102 at operation 134. The transaction processing facility 102 may then process customer's information and generate a reliability score for the customer at operation 136. The payment method selected by the customer is then validated utilizing the reliability score value at operation 138. If there are other approved payment options available for the customer, such other approved payment options are identified utilizing the reliability score value at operation 140. The merchant may then receive the validation information regarding the telephone bill payment option as well as the list of all of the other approved payment options. The list of approved payment options is presented to the customer at operation 142. If the telephone bill payment option is approved at operation 144, the merchant may continue with the sale transaction at operation 146. If the telephone bill payment option is not approved at operation 144, in one embodiment, alternative payment options may be presented to the customer at operation 148, and the customer may select an alternative payment method at operation 150. As the payment alternatives or options have already been validated, the merchant does not need to validate an alternative option selected by the customer from the list of approved payment options. Thus, the present invention may be practiced where an intermediary (e.g., a store clerk) is receiving data from an end user (e.g., a purchaser) and communicating the data to the transaction processing facility 102 of a network-based commerce facility.

Thus, in one embodiment, the method and system uses identification data or information that identifies a user or consumer to generate various different payment options that are presented to the user. The options may be presented to the user are typically options that are considered to be valid or allowable for the specific user. In one embodiment, all valid options may be presented to the user simultaneously. In addition or instead, the valid payment options may be sequentially or serially presented to the user. For example, if a payment option selected by the user fails (e.g. because of vendor criteria, the user having a poor payment history for the particular option, or the like), the system and method may then generate another valid payment option for the particular user. Accordingly, in one embodiment, the system and method may in advance “predict” what options to present to the user or purchaser (e.g., based on the vendor and consumer or any other criteria in the payment option rules engine). However, the system and method may also “dynamically” provide payment options to the user during the transaction process, for example, if a selected payment option fails.

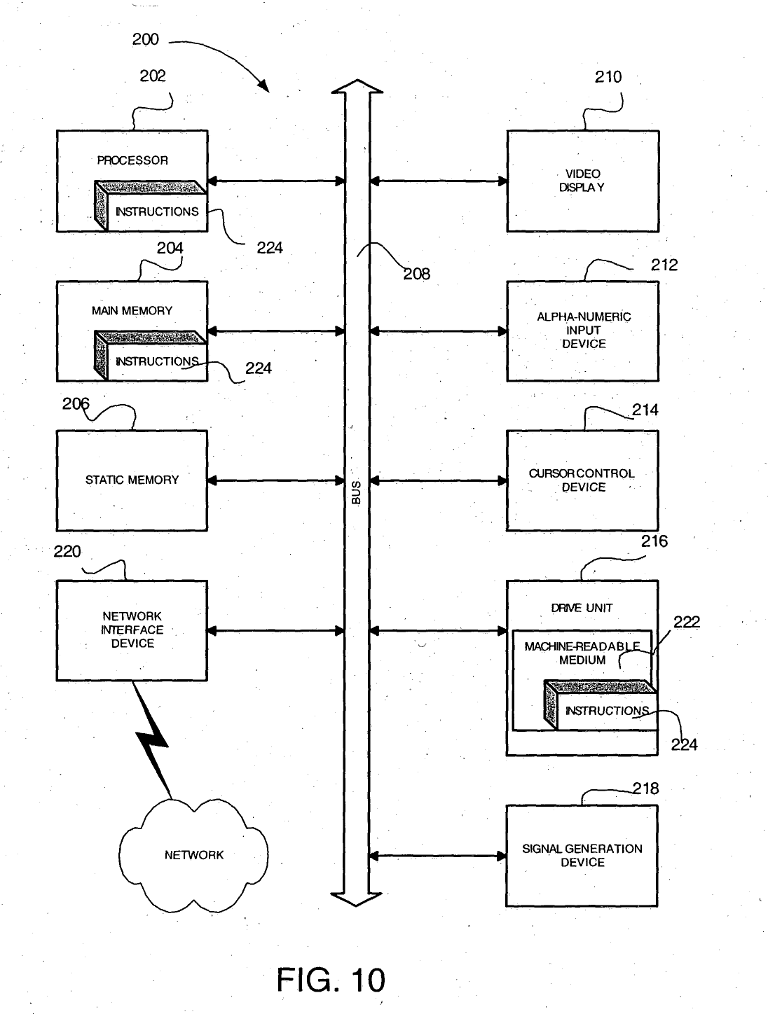

FIG. 10 shows a diagrammatic representation of a machine in the exemplary form of a computer system 200 within which a set of instructions for causing the machine to perform any one of the methodologies discussed above may be executed. In alternative embodiments, the machine may comprise a network router, a network switch, a network bridge, a set-top box (STB), Personal Digital Assistant (PDA), a cellular telephone, a web appliance or any machine capable of executing a set of instructions that specify actions to be taken by that machine.

The computer system 200 includes a processor 202, a main memory 204 and a static memory 206, which communicate with each other via a bus 208. The computer system 200 may further include a video display unit 210 (e.g., a liquid crystal display (LCD) or a cathode ray tube (CRT)). The computer system 200 also includes an alphanumeric input device 212 (e.g., a keyboard), a cursor control device 214 (e.g., a mouse), a disk drive unit 216, a signal generation device 218 (e.g., a speaker) and a network interface device 220.

The disk drive unit 216 includes a machine-readable medium 222 on which is stored a set of instructions (software) 224 embodying any one, or all, of the methodologies or functions described herein. The software 224 is also shown to reside, completely or at least partially, within the main memory 204 and/or within the processor 202. The software 224 may further be transmitted or received via the network interface device 220. For the purposes of this specification, the term “machine-readable medium” shall be taken to include any medium that is capable of storing, encoding or carrying a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals.

Thus, a method and apparatus to process a transaction in a network-based commerce facility has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method to communicate payment options to a consumer, the method including:
receiving consumer information associated with the consumer;
identifying at least one approved payment option from a plurality of payment options utilizing the consumer information, the at least one payment option being valid for the consumer; and
communicating the at least one approved payment option to the consumer for selection by the consumer.

2. The method of claim 1, including:
monitoring a request by the consumer for a further payment option, the further payment option differing from the at least one approved payment option;
communicating to the consumer a request for additional consumer information; and
selectively approving the request by the consumer for the further payment option based on the additional consumer information.

3. The method of claim 1, wherein identifying the at least one approved payment option includes generating a reliability score value utilizing the consumer information.

4. The method of claim 1, wherein identifying the at least one approved payment option includes identifying an available payment option from a plurality of available payment options as an approved payment option for the consumer, utilizing the consumer information.

5. The method of claim 4, including storing the approved payment option for the consumer for use in future transactions.

6. The method of claim 4, wherein the plurality of available payment options include at least one of a credit card option, a phone bill option, an ACH option, a payment by check option, a direct bill option, and a prepayment option.

7. The method of claim 1, wherein identifying the at least one approved payment option to the consumer includes identifying a payment option utilizing at least one of vendor criteria, consumer criteria, type of purchase event criteria, and purchaser payment psychology.

8. A system to present payment options to a consumer, the system including:
a communication module to receive consumer information;
an approved payment options generator module to generate a list of at least one approved payment options utilizing the consumer information; and
a selection module to present the consumer with an option to select a payment option from the list of at least one approved payment options.

9. The system of claim 8, wherein the operation includes providing additional consumer information.

10. The system of claim 8, wherein the payment options generator module includes a payment option validation module to identify an available payment option from a plurality of available payment options as an approved payment option utilizing the consumer information.

11. The system of claim 8, wherein the payment options generator module includes a payment options rules engine to determine reliability score value for the consumer.

12. The system of claim 10, wherein the plurality of available payment options include at least one of a credit card option, a phone bill option, an ACH option, a payment by check option, a direct bill option, and a prepayment option.

13. The system of claim 11, wherein the payment options rules engine is to identify a payment options presentation format, utilizing at least one of a vendor criteria, a consumer criteria, a type of purchase event criteria, and a purchaser payment psychology.

14. A method to present payment options to a consumer, the method including:
providing consumer information associated with the consumer to a transaction processing facility;
receiving at least one approved payment option from a plurality of payment options from the transaction processing facility based on the consumer information, the at least one payment option being valid for the consumer; and
presenting the at least one approved payment option to the consumer for selection by the consumer.

15. The method of claim 14, including:
monitoring a request by the consumer for a further payment option, the further payment option being distinct from the at least one approved payment option;
obtaining additional consumer information from the consumer;
communicating the additional consumer information to the transaction processing facility; and
receiving one of an approval of the further payment option for the consumer, and a rejection of the further payment option for the consumer.

16. A machine-readable medium for embodying a sequence of instructions that, when executed by the machine, cause the machine to:
receive consumer information associated with a consumer;
identify at least one approved payment option from a plurality of payment options utilizing the consumer information, the at least one payment option being valid for the consumer; and
communicate the at least one approved payment option to the consumer for the selection by the consumer.

17. The machine-readable medium of claim 16, in which the machine:
monitors a request by the consumer for a further payment option, the further payment option differing from the at least one approved payment option;
communicates to the consumer a request for additional consumer information; and
selectively approves the request by the consumer for the further payment option based on the additional consumer information.

18. The machine-readable medium of claim 16, wherein the at least one approved payment option is identified by generating a reliability score value utilizing the consumer information.

19. The machine-readable medium of claim 16, wherein the at least one approved payment option is identified by identifying an available payment option from a plurality of available payment options as an approved payment option for the consumer, utilizing the consumer information.

20. The machine-readable medium of claim 19, wherein the approved payment option for the consumer is stored for use in future transactions.

21. The machine-readable medium of claim 19, wherein the plurality of available payment options include at least one of a credit card option, a phone bill option, an ACH option, a payment by check option, a direct bill option, and a prepayment option.

22. The machine-readable medium of claim 16, wherein identifying the at least one approved payment option to the consumer includes identifying a payment option utilizing at least one of vendor criteria, consumer criteria, type of purchase event criteria, and purchaser payment psychology.

23. A system to present valid payment options to a consumer, the system including:
means to receive consumer information;
means to to generate a list of at least one approved payment options utilizing the consumer information; and
means to to present the consumer with an option to select a payment option from the list of at least one approved payment options.

24. A machine-readable medium for embodying a sequence of instructions that, when executed by a machine, cause the machine to:
provide consumer information associated with a consumer to a transaction processing facility;
receive at least one approved payment option from a plurality of payment options from the transaction processing facility based on the consumer information, the at least one payment option being valid for the consumer; and
present the at least one approved payment option to the consumer for selection by the consumer.

25. The machine-readable medium of claim 24, in which the machine:
monitors a request by the consumer for a further payment option, the further payment option being distinct from the at least one approved payment option;
obtains additional consumer information from the consumer;
communicates the additional consumer information to the transaction processing facility; and
receives one of an approval of the further payment option for the consumer, and a rejection of the further payment option for the consumer.
